(19) United States
(12) Patent Application Publication
(10) Pub. No.: US 2003/0196190 A1
(43) Pub. Date: Oct. 16, 2003

(54) Generating and managing test plans for testing computer software

(75) Inventors: Nuzio Ruffolo, Markham (CA); Keith Chan, Markham (CA); Enzo Cialini, Mississauga (CA); Anthony Di Loreto, Markham (CA)

Correspondence Address: Jeffrey S. LaBaw, International Business Machines, Intellectual Property Law, 11400 Burnet Rd.,, Austin, TX, 78758, US

(73) Assignee: INTERNATIONAL BUSINESS MACHINES CORPORATION, ARMONK, NY (US)

(21) Appl. No.: 10/411,466

(22) Filed: Apr. 10, 2003

(30) Foreign Application Priority Data
Apr. 12, 2002 (CA) 2,381,596

(51) Int. Cl. G06F 9/44; H02H 3/05

(52) U.S. Cl. 717/124; 714/38

(57) ABSTRACT

An aspect of the present invention provides a system and a method for generating and managing test plans for guiding a test team through the process of testing computer software. Each component of computer software performs at least one specific task or function. A test plan includes several component test plans each for guiding the test team through the process of testing components of computer software. A component test plan includes a set of test cases or test scenarios. Each test case identifies items (that is, functional aspects of the computer software) for guiding the test team when they test a desired component of software. A distribution list is associated with at least one component of computer software. The distribution list identifies items related to the component of computer software. The distribution list also identifies the number of occurrences of each item in the component test plan (spread amongst several test cases of the component test plan). In a preferred embodiment, one test item is included per test case. Components of computer software and associated distribution lists are identified and subsequently the test plan is generated

### FIELD OF THE INVENTION

This invention relates to test plans, and more specifically this invention relates to generating and managing test plans used for testing computer software.

### BACKGROUND

A team of software developers or a test team manually generates test plans for testing computer software. Test cases are used for testing specific components (that is, parts) of computer software. A software developer manually constructs or generates the test plan by using word processing software or a web page editor such as Netscape™ Composer™. Sometimes, a software developer refers to test cases of previously constructed test plans as a baseline for constructing new test cases. The new test cases are used for testing new components and functions of a new version of computer software. New test cases are added to the test plan for testing aspects of the new component when a new component is added to the new verision of computer software (such as interacting with a computer platform).

When using word processors to manually construct test plans, a significant amount of time is consumed. Problems associated with constructing the test plan include inability to quickly assemble the test plan, inability to preserve a consistent terminology and format across components or functions, inability to provide a summary of the test plan, inability to quickly determine impact of a testcase (that is, a scenario), and inability to print or display desired portions of the test plan.

Accordingly, a system that addresses, at least in part, these and other shortcomings is desired.

### SUMMARY

The present invention provides a system and a method for generating and managing test plans for guiding a test team through the process of testing computer software having components. Each component of computer software performs at least one specific task or function. A test plan includes component test plans. A component test plan guides the test team through the process of testing a component of computer software. A component test plan includes a set of test cases or test scenarios. A test case guides the test team through the process of testing functional aspects (that is, aspects) of the component of computer software related to the component test plan.

Distribution lists are associated with each component of computer software. A distribution list identifies items related to a component of computer software and also identifies a desired number of occurrences of each item in various test cases related to a component test plan. In a preferred embodiment, one test item is included per test case. For each component test plan, an upper limit is set which limits the number occurrences of items included with each test case.

Components of computer software and distribution lists associated with the components of computer software are identified. An upper limit for including items in each test case is identifed. Subsequently, a test plan based on the previously identified parameters is generated.

In an aspect of the present invention, there is provided a method for generating a test plan having a plurality of directions for testing a component of computer software, including inserting test items into a component test plan based on a distribution list identifying limits for including occurrences of the items in the component test plan, each test item identifying a test for a component of computer software, the component test plan providing a collection of tests for testing a component of computer software.

In another aspect of the present invention, there is provided a computer program product for use with a computer including a central processing unit and random access memory, the computer program product including a computer usable medium having computer readable code means embodied in the medium, the computer program product including computer readable program code means for instructing the computer to implement a method for generating a test plan having a plurality of directions for testing a component of computer software, including inserting test items into a component test plan based on a distribution list identifying limits for including occurrences of the items in the component test plan, each test item identifying a test for a component of computer software, the component test plan providing a collection of tests for testing a component of computer software.

In yet another aspect of the present invention, there is provided a method for generating a distribution list used for generating a test plan having test items for testing components of computer software, including determining a correspondence between defects and functions of components of computer software, determining a correspondence between the functions and the test items to be included in a test plan, each test item testing for a component of computer software, and determining a limit of occurrences of test items based on a determined correspondence between defects, functions and test items.

In yet another aspect of the present invention, there is provided a method for generating an impact report including identifying a portion of test plan to be removed from a test plan, the portion of test plan having sub-portions, removing the portion of test plan from the test plan to generate a modified test plan, comparing the portion of test plan against the modified test plan, and generating the report indicating the sub-portions and corresponding occurrences of the sub-portions in the modified test plan. From this report, the impact to our testing coverage can be ascertained (i.e. coverage decrease of 50% for a test item).

A better understanding of these and other aspects of the invention can be obtained with reference to the following drawings and description of the preferred embodiments.

### BRIEF DESCRIPTION OF THE DRAWINGS

The embodiments of the present invention will be explained by way of the following drawings:

FIG. 1A depicts a computing environment for a test plan builder for generating a test plan;

FIG. 1B depicts an example of a components list used by the test plan builder of FIG. 1A;

FIG. 2 depicts operations of the test plan builder of FIG. 1A;

FIG. 3A depicts the test plan builder of FIG. 1A adapted for building test cases;

FIG. 3B depicts an example of a distribution list used by the test plan builder of FIG. 3A, and an example of a test plan generated by the test plan builder of FIG. 3A;

FIG. 4 depicts operations of the test plan builder of FIG. 3A;

FIG. 5A depicts the computing environment of FIG. 1A further including a distribution list builder;

FIG. 5B depicts an example of defects list 506 and an example of functions list 508 used by the distribution list builder of FIG. 5A;

FIG. 6 depicts a development life cycle related to computer software, which provides data used by the distribution list builder of FIG. 5A;

FIG. 7 depicts operations of the distribution list builder of FIG. 5A;

FIG. 8A depicts the computing environment of FIG. 1A further including a impact report generator;

FIG. 8B depicts an example of impact report 804 generated by the impact report generator of FIG. 8A; and

FIG. 9 depicts operations of the impact report generator of FIG. 8A.

### DETAILED DESCRIPTION

In overview, defects in a software component are logged. This is typically the result of customers reporting back defects. The subject system matches each logged defect with a software component function. Each defect and matching function pair is stored in a defects list. The subject system is provided with a list of test items, each test item being one specific test that can be performed on the software component. Commercially available software may be embodied in the system to match each test item with one or more software functions. Each function is stored with and associated item, or items, in a function list. The defects list and function list are then used to build a distribution list for the software component which indicates the number of instances of each test item which should be included in test cases of a test plan for the software component. A “targeted items” list is provided to the system. This list stipulates the maximum number of test items that may be included in each software component test case. A test plan for the software component can then be built. The test plan comprises a series of test cases with each test case chosen so as to have no more than the maximum number of test items as stipulated by the targeted items list. Additionally, the test cases in the test plan, as a group,, per component, include the number of instances of each of the test items in the distribution list as stipulated by the distribution list. The system can also determine the impact of removing a test item or removing a test case from a component test plan.

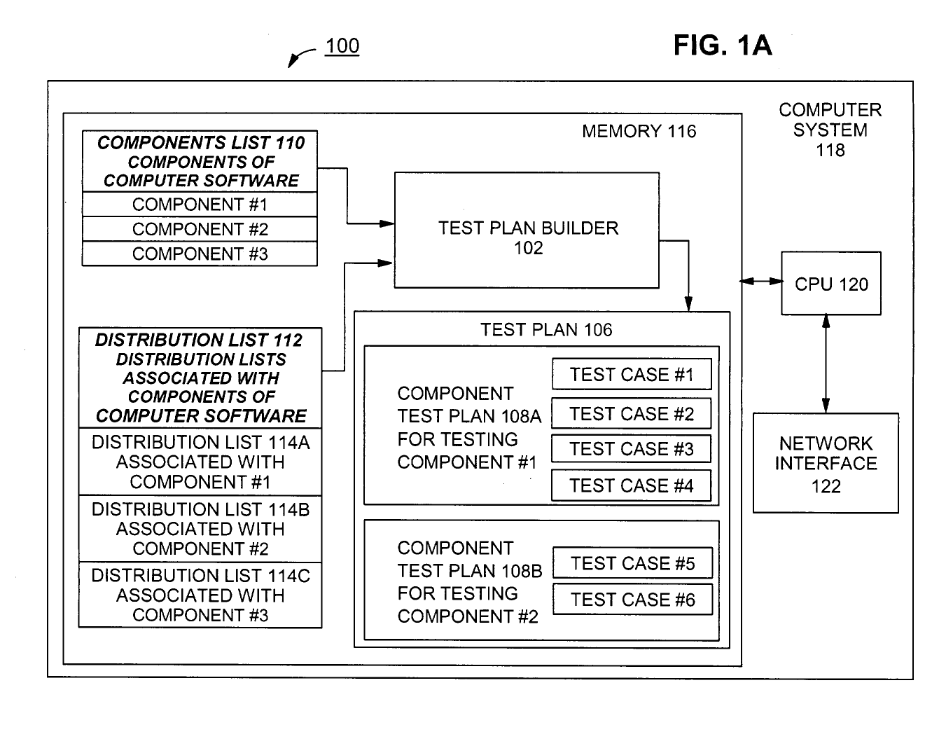

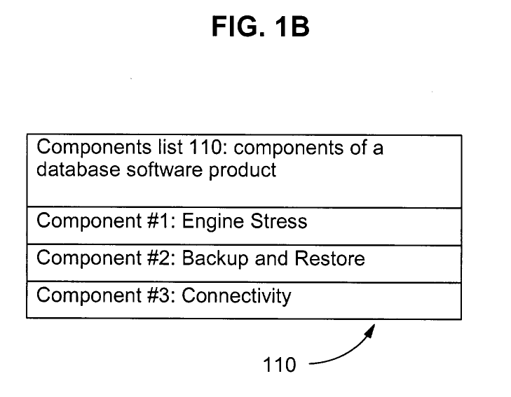

FIG. 1A shows computer system 118 operating in computing environment 100 for generating and managing test plans such as test plan 106. Computer system 118 includes central processing unit (CPU) 120 operatively coupled to memory 116, to network interface 122, and to disk storage interface device (not depicted) for receiving computer program product 123. Computer program product 123 includes computer readable media having computer programmed instructions embodied thereon which includes code and/or data for directing the CPU 120 to perform operations of test plan builder 102, or includes code and/or data for setting up test plan builder 102. It will be appreciated that the code of computer program product 123 can optionally transported to memory 116 via a network, such as the Internet, connected to network interface 122.

Memory 116 is a computer readable media for storing computer readable data and/or computer executable software having instructions for directing CPU 120 to achieve specific tasks or functions. Optionally, network interface 122 interfaces CPU 120 to a network (not depicted) such as the Internet and the like. Test plan builder 102, test plan 106, components list 110 and master distribution list 112 are also stored in memory 116. Components list 110 identifies components of computer software. Master distribution list 112 identifies distribution lists associated with the components of computer software (herein after called ‘components of software’).

Test plan builder 102 is computer executable software or program having computer programmed instructions or code written in a computer programming language for directing operations of CPU 120. Test plan builder 102 directs CPU 120 to generate (construct or build) test plan 106 in response to examining components list 110 and master distribution list 112. Test plan builder 102 can be stored on a computer readable transport media such as a floppy disk for transport to memory 116 via known interfacing mechanisms. Alternatively, test plan builder 102 can be transported from a networked computer (not depicted) over a network operatively connected to network interface 122 for storage in memory 1

A team of software developers or a test team refers to test plan 106 as a guide while testing computer software, components of computer software, and functions or aspects (such as reliability) of the computer software. An example of computer software is DB2™ Universal Database manufactured by IBM Corporation of Armonk, N.Y., U.S.A. Computer software includes components (that is, parts) of computer software. A component of software provides one or more functions such as printing, viewing documents and the like.

Components list 110 identifies components of computer software such as component #1, component #2 and component #3. A test team constructs components list 110. Test plan builder 102 examines components list 110 and master distribution list 112 to subsequently generate test plan 106. Test plan 106 includes a plurality of component test plans. A component test plan is used by the test team as a guide while they test a component of software related to the component test plan. For example, members of the test team refer to component test plan 108A and component test plan 108B for guiding them while they test component #1 and component #2 respectively. An example of components list 110 is shown in FIG. 1B.

Referring to the example shown in FIG. 1B, Engine Stress is a component of a database software program for directing CPU 120 to stress a database. Backup and Restore is another component of the database software program for directing CPU 120 to back up and restore the database. Connectivity is yet another component of the database software program for connecting the database to a network.

Master distribution list 112 identifies distribution lists 114A, 114B, 114C associated with component #1, component #2 and component #3 respectively. In a preferred embodiment, each distribution list is associated with one component of computer software. A distribution list identifies items that are to be included in a component test plan. An item is a feature, a task or a function related to a specific component of computer software. A distribution list also identifies a frequency (that is, a number of occurrences) with which to include each item in various test cases associated with the component test plan, as will be described in greater detail below.

Test plan builder 102 examines master distribution list 112 to identify a distribution list associated with a component identified in components list 110. Subsequently, test plan builder 102 generates component test plans corresponding to components identified in components list 110. Test plan builder 102 generates and inserts test cases (such as test case #1, test case #2, test case #3 and test case #4) into the component test plans (such as component test plan 108A). For example, since test plan builder 102 identified component #1 in components list 110, and identified (in master distribution list 112) distribution list 114A associated with component #1, component test plan 108A is generated. A test team refers to a component test plan 108A to guide them while they test component #1. A component test plan includes test cases which contain items identified from a distribution list associated with the component test plan as will be described in greater detail below.

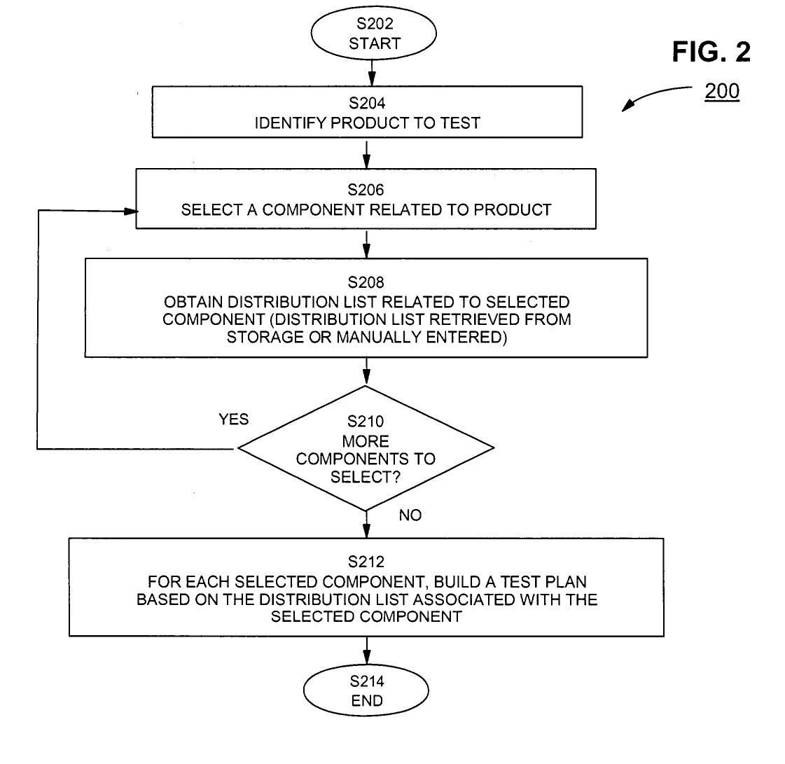

FIG. 2 shows operation 200 of test plan builder 102 of FIG. 1A. The operation 200 is performed by test plan builder 102 unless stated otherwise. Operation 200 matches each component identified by the test plan builder 102 with a distribution list associated with the identified component. Once each identified component is matched up with a corresponding distribution list, a test plan is built for each identified component (operation S212). Operation S212 is described in greater detail in the description related to FIG. 2. Operation S202 indicates that operation of test plan builder 102 begins.

Test plan builder 102 identifies computer software to be tested (S204). In a preferred embodiment, a user instructs test plan builder 102 to select the computer software to be tested. Test plan builder 102 selects components related to the computer software (S206). Test plan builder 102 examines components list 110 to identify components of computer software to be tested. Test plan builder 102 identifies component #1, component #2, and component #3 from components list 110. Alternatively, a user identifies components of software via keyboard entry (not depicted) in place of using components list 110 to identify components of software.

Test plan builder 102 examines a distribution list associated with or corresponding with a selected component of computer software (S208). Test plan builder 102 identifies distribution list 114A, distribution list 114B, and distribution list 114C from master distribution list 112. Lists 114A, 114B, and 114C correspond to component #1, component #2, and component #3 respectively. Alternatively, a user can individually identify distribution lists associated with selected components or can manually identify distribution lists via keyboard entry.

Test plan builder 102 ascertains whether there are additional components of software to be selected (S210). If there are additional components to be selected, operations continue to S206 in which another component of software is selected. If no additional components are to be selected, operations continue to S212. Test plan builder 102 builds, for each selected component, a test plan based on a distribution list associated with a selected component (S212). Based on distribution list 114A and distribution list 114B, test plan builder 102 generates test plan 106 having component test plans 108A and 108B each respectively associated with distribution lists 114A, 114B. FIG. 2 does not depict test plan 106 also including component test plan 108C associated with distribution list 112C. Test plan builder 102 generates each test case having various items as will be explained in greater detail below. Test plan builder 102 ends operations (S214). A generated component test plan includes test cases each identifying items to be tested as will be described in greater detail below.

An embodiment of the present invention provides a method for generating a test plan having many directions for testing a component of computer software. The method includes operations for inserting test items into a component test plan based on a distribution list identifying limits for including occurrences of the test items in the component test plan, in which each test item identifies a test for a component of computer software, and in which the component test plan provides a collection of tests for testing a component of computer software. Alternatively, the method can be modified in which each test item identifies a direction for testing an aspect corresponding to the component of computer software. Alternatively, the method can include an operation for inserting the component test plan in the test plan. In another embodiment, the method can further include organizing the test items into groups of test cases, in which each group of test cases includes a unique combination of occurrences of the test items. Alternatively, the method can be further modified in which each test item is for testing one of a feature, a task, and a function which corresponds to the component of computer software. Alternatively, the method further includes limiting the number of occurrences of items in each test case.

Another embodiment of the present invention provides a computer program product for use with a computer including a central processing unit and random access memory, the computer program product includes a computer usable medium having computer readable code (written in a computer programmed instructions) embodied in the medium. The computer program product includes computer readable program code for instructing the computer to implement operations of the methods detailed in the paragraph above.

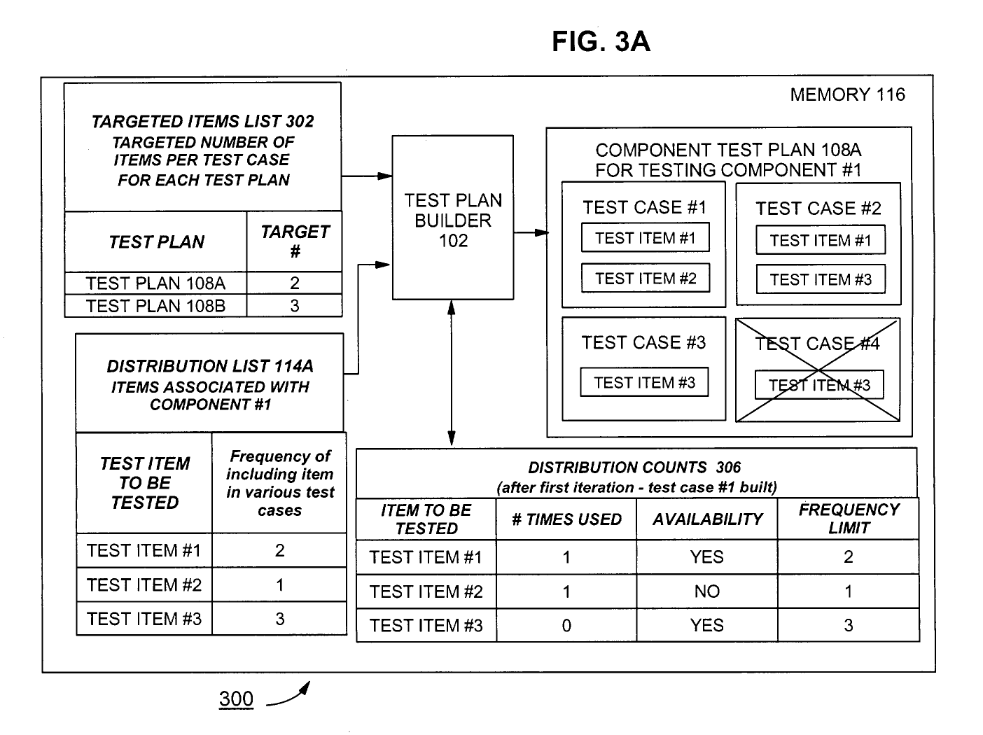

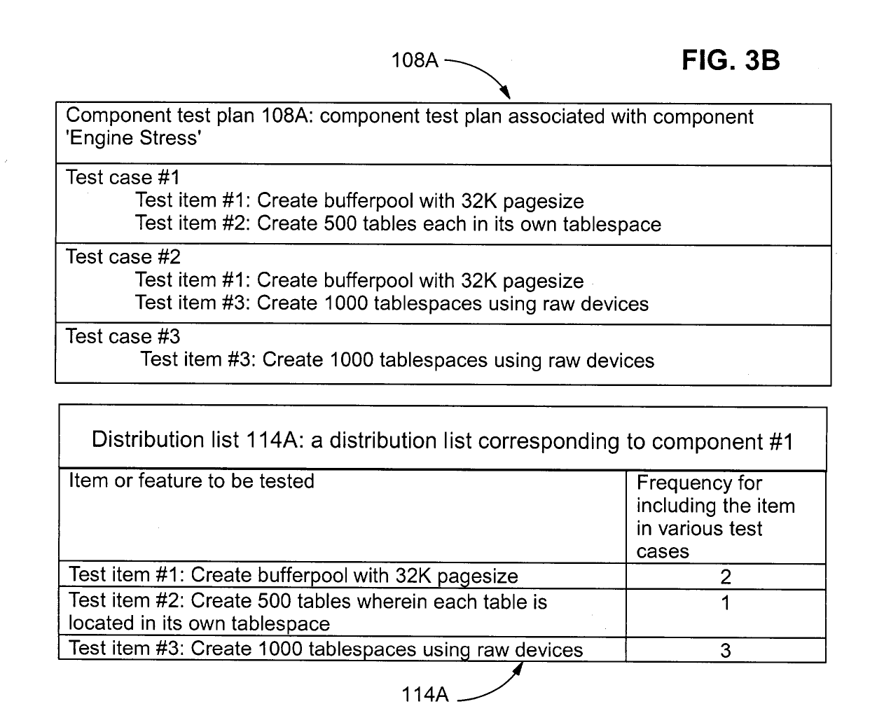

FIG. 3A shows computing environment 100 including test plan builder 102 of FIG. 1A in which test plan builder 102 is adapted for generating test cases. Computing environment 100 also includes targeted items list 302, distribution list 114A, distribution counts 306, and test plan 108A. An example of test plan 108A is shown in FIG. 3B.

Test plan builder 102 examines targeted items list 302 and distribution list 114A to generate test cases (each having test items) for inclusion with test plan 108A. Additionally, test plan builder 102 generates distribution counts 306 to keep track of the number of occurrences of items inserted in the test cases. For example, component test plan 108A includes test case #1, test case #2, test case #3, and test case #4. Each generated test case includes a set of test items which are chosen from items identified in a distribution list such as distribution list 114A as will be explained below.

Targeted items list 302 identifies a maximum number of targeted or unique test items to be included with each test case for each test plan. These numbers are selected or determined by the user and inputted into the test plan builder 102. For example, since targeted items list 302 identifies a maximum number of targeted unique test items to be at most two test items per test case related to component test plan 108A , each test case of component test plan 108A includes at most two test items that will guide the test team while they test component #1. Test case #1 includes two test items (that is, test item #1 and test item #2 ). Test case #2 includes two test items (that is, test item #1 and test item #3 ). Test case #3 includes one test item (that is, test item #3 ). The method for determining which items are included with which test cases will be described below. Distribution of counts 306 is used by test plan builder 102 for determining which items have been included in a test case.

Distribution list 114A is associated with component #1. The association of distribution lists with components of software are predetermined by members of a test team. Distribution list 114A identifies items to be tested such as test item #1, test item #2 and test item #3. Also identified in distribution list 114A are corresponding frequencies with which identified or selected items are to appear in various test cases included in test plan 108A . In a preferred embodiment, an item is included at most only once in any particular test case, and identical test cases are not implemented. Even though item #3 was included in test case #4, test case #4 was not implemented because it is identical to test case #3.

Targeted items list 302 identifies a maximum limit of the number of items for each test case. Distribution list 114A identifies a maximum limit of the number of occurrences of an item within the entire group of test cases related to a component test plan. For example, since targeted items list 302 identifies the maximum limit of two test items per test case, test plan builder 102 generates test case #1 having two test items, test case #2 having two test items, and test case #3 having one test item. Since distribution list 114A identifies that maximum limit of two occurrences of test item #1 in component test plan 108A , test plan builder 102 generates test case #1 having test item #1 and test case #2 having test item #1 (therefore, the number of occurrences of test item #1 is two). It will be appreciated that test case #3 includes one test item (that is, test item #3 ) because the maximum occurrences of other items (that is test item #1 and test item #2 ) have reached their respective limits. Also, test item #3 occurs twice rather than occurring three times as identified in distribution list 114A because the maximum occurrences of other items have reached their limits and test case #4 was not included since it is equivalent to test case #3. An example of distribution list 114A is shown in FIG. 3B.

An item of a distribution list identifies a task to be performed by members of a test team. For example, test item #1 requires the test team to create a bufferpool with a 32K pagesize. Test item #2 requires the test team to create 500 tables wherein each table is located in its own tablespace. Test item #3 requires the test team to create 1000 tablespaces using raw devices. The item is to be included in various test cases related to a component test plan. Associated with each item of the distribution list is an identification for identifying a desired frequency for including occurrences of an item in a group of test cases related to a component test plan. Upon examination of the example table 108A of FIG. 3B, an occurrence of test item #1 may be inserted up to two times in the group of test cases related to a component test plan. Preferably, an occurrence of test item #1 is inserted once in one test case and then once in another test case, an occurrence of test item #2 is inserted up to a maximum of once in the group of test cases, and an occurrence of test item #3 is inserted up to a maximum of three times in the group of test cases (but not move them once assigned to any given test case). A test case lists or identifies items to be tested by the test team. The items are identified and selected from a distribution list such as distribution list 114A .

Distribution counts 306 is a temporary list created by test plan builder 102. Once test plan 108A has been constructed, distribution counts 306 is not retained. The manner in which test plan builder 102 uses distribution counts 306 will be explained below.

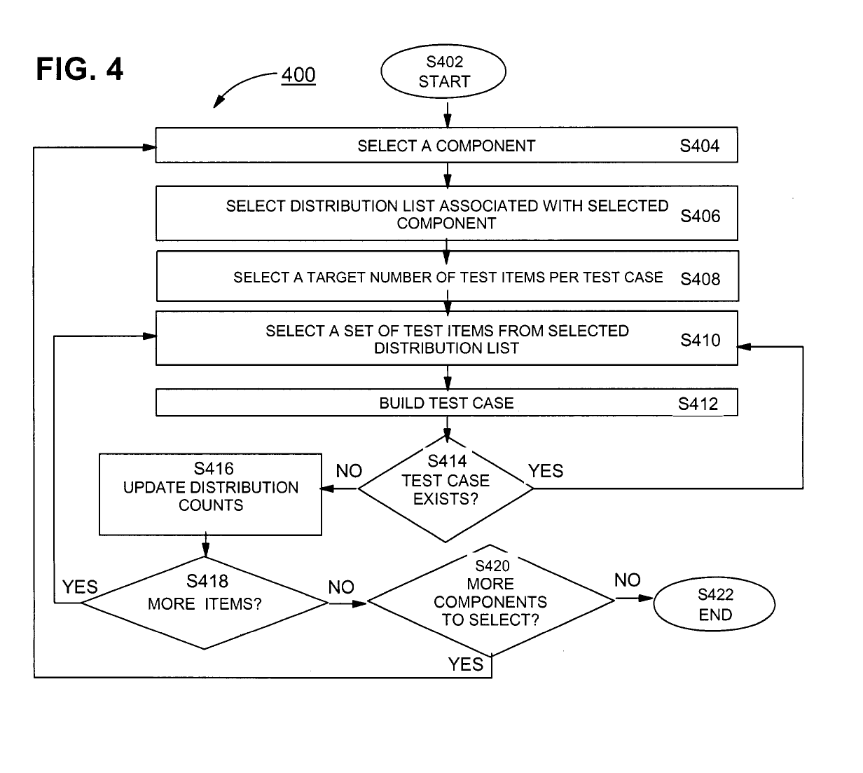

FIG. 4 shows operation 400 of test plan builder 102 of FIG. 3A. It is understood that operation 400 is performed by test plan builder 102 unless stated otherwise. Operation 400 builds a test plan for each identified component by including test cases in each built test plan in accordance with a distribution list (indicating test items and frequency for including each test item) associated with the identified component and in accordance with a target number of test items per test case. Operation S402 indicates that operation of test plan builder 102 begins.

Test plan builder 102 examines components list 110 and selects a component of software (such as component #1 ) for which a component test plan will be generated (S404). Test plan builder 102 selects a distribution list associated with the selected component (S406). Since component #1 was identified and selected, distribution list 114A associated with selected component #1 is selected for generating component test plan 108A .

Test plan builder 102 selects a targeted number of items that can be included in a test case (S408). Targeted items list 302 indicates that, for component test plan 108A , test plan builder 102 can generate test cases each having up to a maximum of two different or unique test items. Alternatively, a user can manually enter the number of targeted items for a component test plan via keyboard entry. Referring to component test plan 108A , test case #1 and test case #2 each have up to a maximum of two different items as specified in targeted items list 302. However, test case #3 has less than the maximum of two different items (namely, test item #3 ) because distribution list 114A identifies the maximum number of occurences of items #1 and #2 must not exceed two occurrences and one occurrence respectively. The maximum number of occurrences of test item #1 and test item #2 were included with either test case #1 and test case #2.

Test plan builder 102 selects a set of items to be included with each test case (S410). Test plan builder 102 selects and inserts test item #1 and test item #2 into test case #1 because targeted items list 302 limits the number of items per test case to two different items. Referring to distribution counts 306, after test case #1 has been generated test plan builder 102 notes in distribution counts 306 that test item #1 was used once and that test item #1 is still available for inclusion in the next generated test case (that is, test case #2 ) because the limit for test item #1 has not yet been reached (the frequency limit is found in distribution list 114A ). Also noted in distribution counts 306, test item #2 was used once and that test item #2 is no longer available for inclusion in a next generated test case (that is, test case #2 ) because distribution list 114A indicates that test item #2 is to be used once in various test cases for component #1. Also noted in distribution counts 306, test item #3 was not included in test case #1 because the maximum number of items was inserted into test case #1. Test plan builder 102 selects and inserts test item #1 and test item #3 into test case #2 because distribution list 114A limits the number of occurrences of test item #2 that can be inserted (test item #2 can only be used once). Test plan builder 102 selects and inserts test item #3 into test case #3 because distribution list 114A limits the occurrence of test item #1 to two occurrences and test item #2 to one occurrence.

Test plan builder 102 generates test cases for insertion into a component test plan (S412). Test plan builder generates test case #1 having test item #1 and test item #2, test case #2 having test item #1 and test item #3, and test case #3 having test item #3 by following the logic outlined above.

Test plan builder 102 ascertains whether a newly generated test case already exists (S414). If the newly generated test case already exists, the newly constructed test case is deleted and processing continues to S410 (in which a new set of items is selected). If the newly generated test case does not already exist, processing continues to S416. It will be appreciated that test case #4 of component test plan 108A would not be generated because test case #3 already exists and it is identical to test case #4. Therefore test case #4 is redundant and not required.

Test plan builder 102 iteratively updates distribution counts such as distribution counts 306 (S416). Since test item #1 and test item #2 were previously selected in S410, the ‘number of times used’ column is incremented by ‘1’ for test item #1 and for test item #2. Since the upper limit of the number of occurrences of test item #1 is two occurrences, additional occurrences of test item #1 are available for insertion into other test cases during other iterations of S410 (and as such the ‘availability’ column for test item #1 in distribution counts 306 is marked ‘yes’). Since the upper limit of the number of occurrences of test item #2 is one occurrence, additional occurrences of test item #2 are not available for insertion into another test case during other iterations of S410 (and as such the availability column for test item #2 is marked as ‘No’).

Test plan builder 102 ascertains whether there are any additional items that should be inserted into another test case related to a component test plan (S418). For example, this operation checks the ‘number of times used’ column in distribution counts 306 and ‘frequency limit’ column in distribution counts 306. If there are additional items that should be inserted into another test case, processing continues to S410 and another item is selected for insertion into another test case. For example, test item #1 and test item #3 (for a second iteration) will be inserted into test case #2. If no additional items are to be inserted into other test cases, processing continues to S420.

Test plan builder 102 ascertains whether there are other components of software to be selected (S420). If there is another component of software to be selected (such as from components list 110), processing continues to S404 in which another component of software is identified and selected (and a new commponent test plan is generated). If there are no additional components to select or identify, processing continues to S422 in which case operations of test plan builder 102 stops.

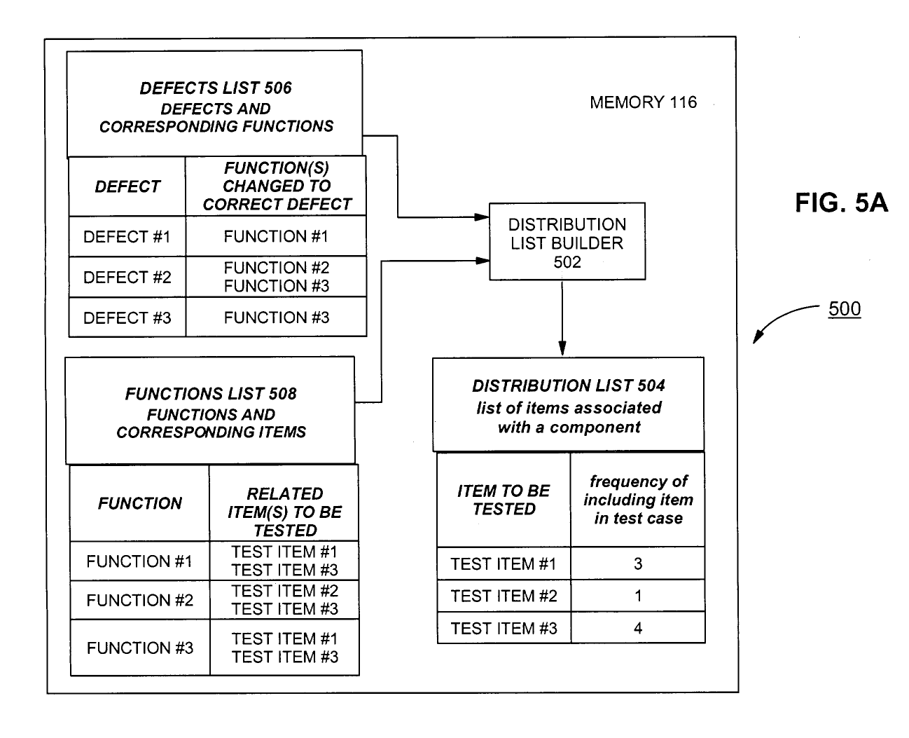

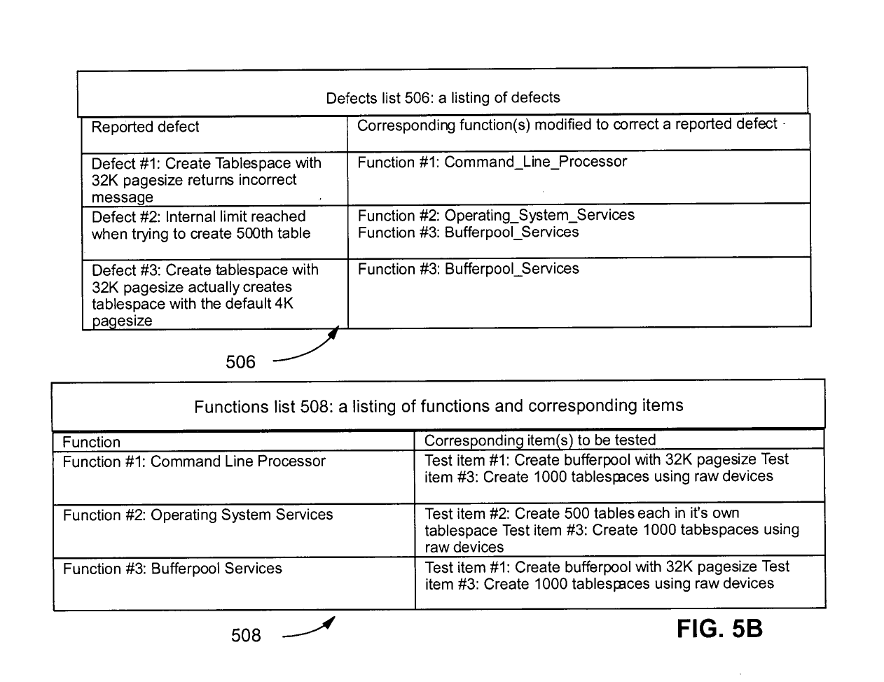

FIG. 5A shows computing environment 100 of FIG. 1A that further includes other software components such as distribution list builder 502. It will be appreciated that distribution list builder 502 can operate independently of test plan builder 102. Preferrably, distribution list builder 502 operates in conjunction with test plan builder 102. Distribution list builder 502 examines defects list 506 and functions list 508 to generate distribution list 504. Defects are matched to functions by using known methods such as diagnostic information mechanisms such as DB2™ Universal Database™ Trace Facility or DB2 Universal Database Diagnostics Log File available from IBM Corporation, or in manually reviewing function and defect information. As problems occur in a function, a fix (that is, a portion of code is fixed) is attempted. If the fix solves the problem, a clear mapping can be established. If the attempted fix does not solve the problem, another fix is attempted until a resolution can be established or verified for the defect. Once a fix resolves the defect, a clear mapping can be made between a function and defect. Distribution list 504 is used by test plan builder 102 for generating test plans and test cases as described above.

A defects list identifies defects related to computer software, and also identifies functions of the computer software that are related to (corresponds to) the identified defects. For example, defects list 506 identifies defect #1 which corresponds to function #1, identifies defect #2 which simultaneously corresponds to function #2 and function #3, and identifies defect #3 which corresponds to function #3. An example of defects list 506 is shown in FIG. 5B.

A functions list identifies functions of computer software components and items which are correspondingly related to the identifed functions. For example, functions list 508 identifies function #1 which simultaneously corresponds to test item #1 and test item #3, identifies function #2 which simultaneously corresponds to test item #2 and test item #3, and identifies function #3 which simultaneously corresponds to test item #1 and test item #3. An example of functions list 508 is shown in FIG. 5B.

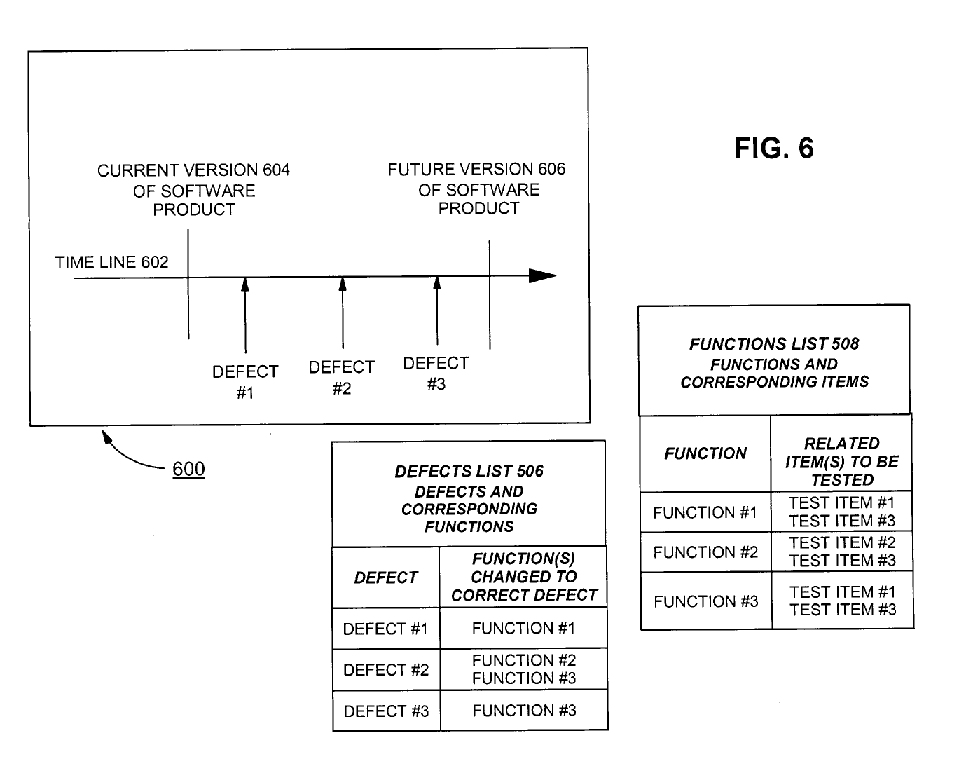

FIG. 6 shows a software development life cycle from which defects list 506 and functions list 508 of FIG. 5A were created and developed. Time line 602 proceeds from left to right in an ascending progression of time. At an earlier date, a current version 604 of computer software was created. At a later date, a future version 606 of computer software will be created. A test plan will be generated for guiding a test team while they test future version 606. However, before generating the test plan, defects list 506 and functions list 508 are generated. It is expected that after the current version 604 has been shipped to end users, defects related to current version 604 will be reported by the end users. For example, once defect #1 is reported, its occurrence is recorded in defects list 506. An evaluation of current version 604 may reveal that function #1 relates to defect #1 and this fact is also noted in defects list 506. Subsequently, function #1 of current version 604 is repaired and it no longer suffers from reported defect #1. Once defect #2 is reported, its occurrence is recorded in defects list 506. Another evaluation of current version 604 reveals that function #2 and function #3 relate to defect #2 and this fact is also noted in defects list 506. Subsequently, function #2 and function #3 of current version 604 are repaired and they no longer suffer from reported defect #2. Once defect #3 is reported, its occurrence is recorded in defects list 506. Another evaluation of current version 604 reveals that function #3 relates to defect #3 and this fact is also noted in defects list 506. Subsequently, function #3 is repaired and it no longer suffers from reported defect #3.

Before generating a distribution list, functions list 508 is generated. An evaluation of functions identified in defects list 506 is conducted in which test items are related or matched up with the identified functions, and subsequenlty functions list 508 is generated. The task of matching up test items with functions can be performed based on tester experience. Preferrably, a commericially available code coverage tool is used for systematically matching test items with functions of software code. An example of a commercially available tester or test tool is the Rational Test RealTime Coverage available from Rational of California. The manner for generating the test items can be varied and depends on the skill of the user who assembles the test items. The test items can be assembled from old test plans, from user experience, from functional specifications of the software to be tested, and documentation related to the software to be tested. Functions list 508 is an ever evolving list throughout the life of computer software product.

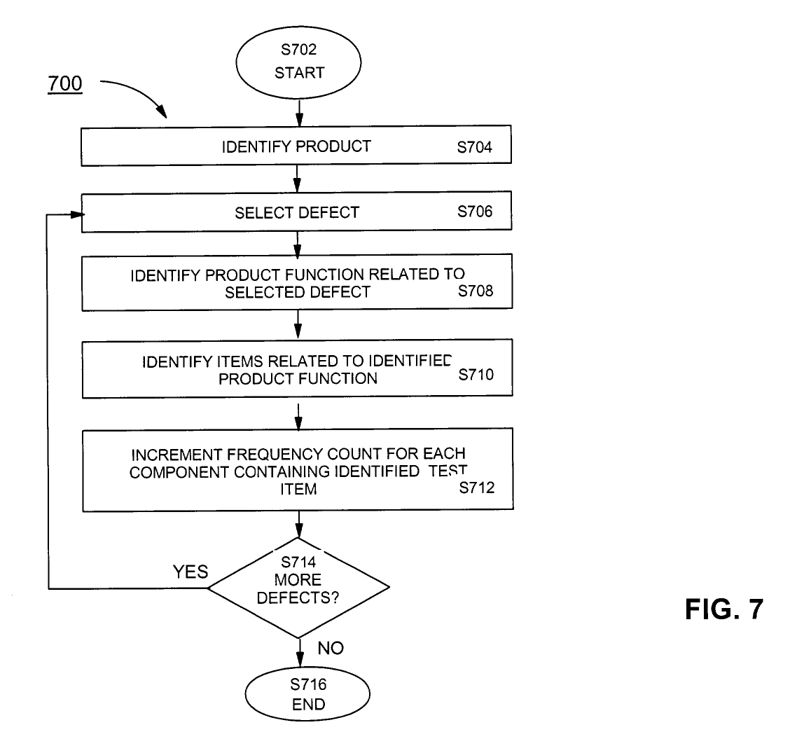

FIG. 7 shows operations 700 of distribution list builder 502 of FIG. 5A. It is understood that operations 700 are performed by distribution list builder 502 unless stated otherwise. Operation S702 indicates the start of operations of distribution list builder 502.

A user identifies, to distribution list builder 502, computer software that will be tested (S704). Distribution list builder 502 will generate various distribution lists, such as distribution list 504, that are subsequently used by test plan builder 102 of FIG. 1A.

Distribution list builder 502 selects a defect (S706). During a first iteration of operation S706, defect #1 is selected from defects list 506. During a second iteration of operation S706, defect #2 is selected from defects list 506. During a third iteration of operation S706, defect #3 is selected from defects list 506.

Distribution list builder 502 identifies a function (that is a function of computer software) related to an identifed or selected defect (S708). For a first iteration of operation S708, defects list 506 is examined and it is determined that function #1 relates to selected defect #1. For a second iteration of operation S708, defects list 506 is examined and it is determined that function #2 and function #3 relate to defect #2. For a third iteration of operation S708, defects list 506 is examined and it is determined that function #3 relates to defect #3.

Distribution list builder 502 identifies items related to an identified function (S710). For a first iteration of operation S710, functions list 508 is examined and it is determined that test item #1 and test item #3 relate to function #1. For a second iteration of operation S710, functions list 508 is examined and it is determined that test item #2 and test item #3 relate to function #2. For a third iteration of operation S710, functions list 508 is examined and it is determined that test item #1 and test item #3 relate to function #3.

Distribution list builder 502 increments a frequency counter for each occurrence of a test item identified with an identified defect (S712). Before any iterations of operation S712, counter values of test item #1, test item #2 and test item #3 are all set to zero. For the first iteration of operation S712, it has been previously determined that defect #1 relates to function #1 which in turn relates to test item #1 and test item #3, and therefore frequency counters related to test item #1 and test item #3 are both incremented by ‘1’. At the end of the first iteration of operation S712, the counter value of test item #1 is ‘1’, the counter value of test item #2 is ‘0’, and the counter value of test item #3 is ‘1’. For a second iteration of operation S712, it has been previously determined that defect #2 relates to function #2 which in total relates to test item #2 and test item #3, and therefore frequency counters related to test item #2 and test item #3 are both incremented by ‘1’. However, it has also been previously determined that defect #2 relates to function #3 which in total relates to test item #1 and test item #3, and therefore frequency counters related to test item #1 and test item #3 are both incremented by ‘1’. At the end of the second iteration of operation S712, the counter value of test item #1 is ‘2’, the counter value of test item #2 is ‘1’, and the counter value of test item #3 is ‘3’. For a third iteration of operation S712, it has been previously determined that defect #3 relates to function #3 which in turn relates to test item #1 and test item #3, and therefore frequency counters related to test item #1 and test item #3 are both incremented by ‘1’. At the end of the third iteration of operation S712, the counter value of test item #1 is ‘3’, the counter value of test item #2 is ‘1’, and the counter value of test item #3 is ‘4’. Distribution list 504 shows the frequency counter values for the third iteration of operation S712.

Distribution list builder 502 ascertains whether there are more defects to select (S714). This is a mechanism to enable iterations of operations S706, S708, S710 and S712. If there are more defects to select, processing continues to S706 and iterations of previosuly mentioned operations may occur. If there are no additional defects to select, processing continues to operation S716 in which operations of distribution list builder 502 stops.

In embodiments that provide a method for generating a test plan, the method can include an additional operation for generating a distribution list used for generating a test plan having test items for testing components of computer software. Alternatively, the method can be adapted in which the operation of generating the distribution list includes operation for determining a correspondence between defects and functions of components of computer software, operation for determining a correspondence between said functions and said test items to be included in a test plan, each test item testing for a component of computer software, and operation for determining a limit of occurrences of test items based on a determined correspondence between defects, functions and test items. Alternatively, the method can be further adapted to include operation for generating an impact report. In another embodiment, a separate method can be provided for generating a distribution list used for generating a test plan having test items for testing components of computer software independently of the method for generating a test plan.

Another embodiment of the present invention provides a computer program product for use with a computer including a central processing unit and random access memory, the computer program product includes a computer usable medium having computer readable code (written in a computer programmed instructions) embodied in the medium. The computer program product includes computer readable program code for instructing the computer to implement operations of the methods detailed in the paragraph above.

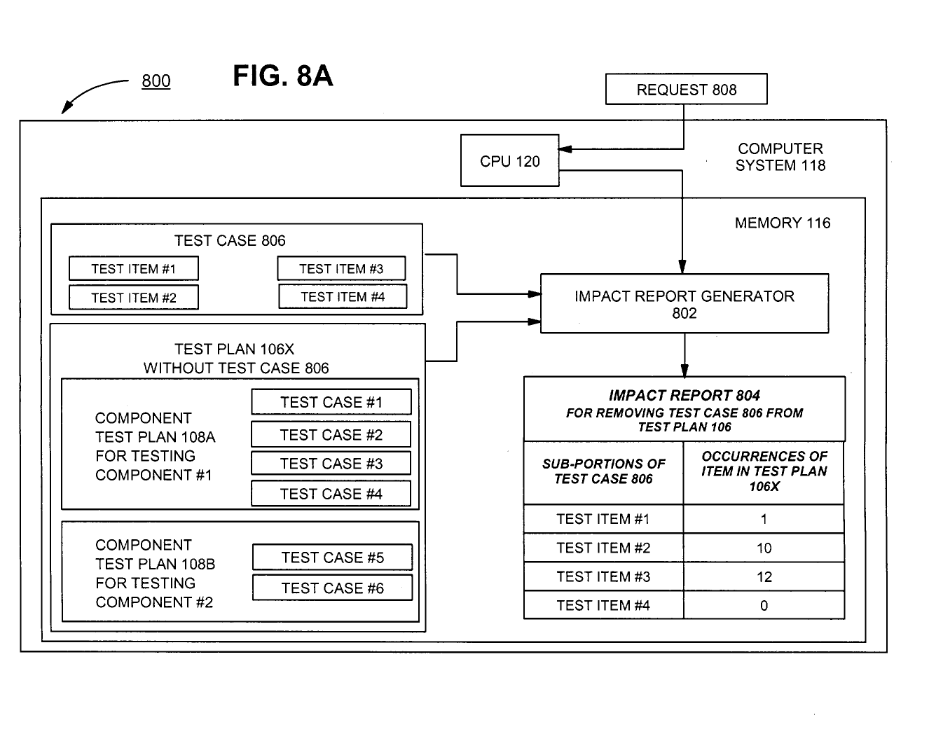

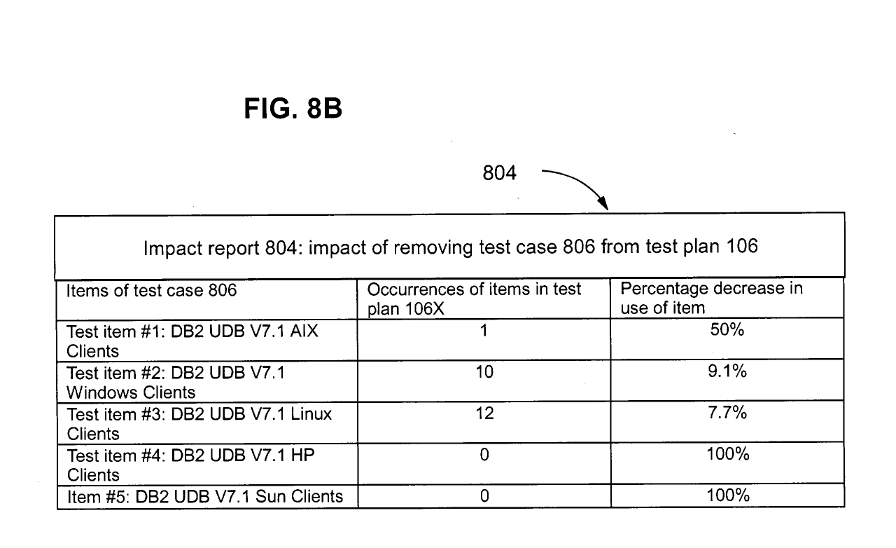

FIG. 8A shows computing environment 100 of FIG. 1A also including impact report generator 802 for generating impact report 804. Impact report 804 is a summary of items that will be impacted if a portion or sub-portion (such as a test case or a component test plan) is removed from a test plan. For example, a software development team may be contemplating the impact of removing test case 806 from test plan 106 (not shown) before actually using a modified version of test plan 106. The modified version of test plan 106 is shown as test plan 106X. Before proceeding with generating an impact report, test case 806 is removed from test plan 106 to generate test plan 106X. After receiving request 808 (that is, a request to generate the impact report), impact report generator 802 examines test plan 106X and test case 806, and subsequently generates impact report 804. Impact report 804 indicates the impact of removing test case 806 from test plan 106.

An example of impact report 804 is shown in FIG. 8B.

Impact report 804 provides a summary of occurrences of items of test case 806 in test plan 106X. Impact report 804 indicates that there is one occurrence of test item #1 in test plan 106X. By deduction, there must be two occurrences of test item #1 in test plan 106. This is done by deduction because report 804 generated taking items in test case 806 which includes test item #1 and the rest of the plan which according to report 804 includes one occurrence of item #1 remaining in test plan 106X. Therefore, the impact of removing test case 806 from test plan 106 is that usage of test item #1 will decrease by 50% (that is, by ½), and therefore there will be a 50% reduction in test coverage for test item #1. Impact report 804 also indicates that there are ten occurrences of test item #2 in test plan 106X. By deduction, there must be eleven occurrences of test item #2 in test plan 106. Therefore, the impact of removing test case 806 from test plan 106 is that usage of test item #2 will decrease by 9.1% (that is, by 1/11), and therefore there will be a 9.1% reduction in test coverage for test item #2. Impact report 804 also indicates that there are 12 occurrences of test item #3 in test plan 106X. By deduction, there must have been 13 occurrences of test item #3 in test plan 106. Therefore, the impact of removing test case 806 from test plan 106 is that usage of test item #3 will decrease by 7.7% (that is, by 1/13), and therefore there will be a 7.7% reduction in test coverage for test item #3. Impact report 804 also indicates that there are zero occurrences of test item #4 in test plan 106X. By deduction, there must have been one occurrence of test item #4 in test plan 106X. Therefore, the impact of removing test case 806 from test plan 106 is that usage of test item #4 will decrease by 100%.

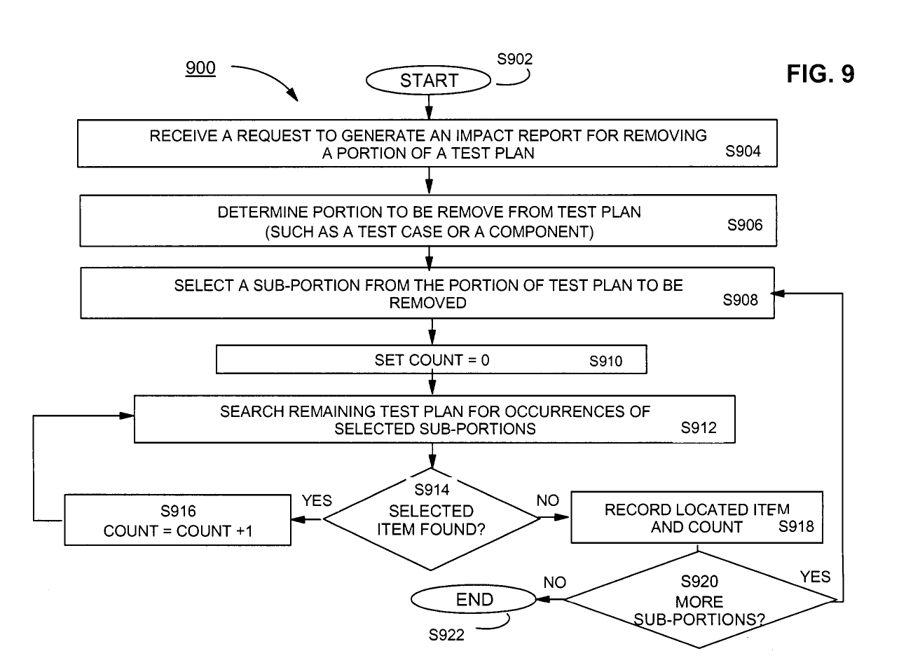

FIG. 9 shows operations 900 of impact report generator 802 of FIG. 8A. It is understood that operations 900 will be performed by impact report generator 802 unless stated otherwise. Operation S 902 indicates the start of operations of impact report generator 802.

Impact report generator 802 receives a request to generate or construct an impact report, such as impact report 804, for indicating the impact of removing a portion or sub-portion of a test plan from the test plan (S904). Via keyboard entry, a user submits request 808 to CPU 120 which in turn directs impact report generator 802 to generate impact report 804. Prior to submitting request 808, the user generates test case 806 (which is a portion that is being considered for removal from test plan 106) and test plan 106X (which is test plan 106 having test case 806 removed therefrom). Optionally, the test plan 106X does not need to be generated by a user, but can be easily generated by the CPU. Subsequently, the user sends request 808 to CPU 120 which in turn directs impact report generator 802 to generate impact report 804. Preferrably, request 808 identifies test case 806 and test plan 106X.

Impact report generator 802 identifies which portion of a test plan is to be removed (S906). The portion of the test plan can be a test case, a component test plan or portions thereof. FIG. 8A shows a portion of the test plan to be removed is test case 806.

Each iteration of operation S908 causes impact report generator 802 to select sub-portions from a portion of test plan selected for removal (S908). If the portion of test plan is a test case (which is the case shown in FIG. 8A), the sub-portions are items of the test case. Therefore, for a first, a second, a third and a fourth iteration of operation S908 impact report generator selects test item #1, test item #2, test item #3 and test item #4 respectively from test case 806. If the portion of test plan selected for removal is a component test plan such as component test plan 108A , the sub-portions are test cases related the component test plan (such as test case #1, test case #2, test case #3 and test case #4 related to component test plan 108A ) and the sub-portions are also test items related to each test case of component test plan 108A . Shown in FIG. 8A is impact report 804 identifying or listing sub-portions of test case 806.

Impact report generator 802 initializes counters of each identified sub-portion to zero (S910). The counters are used for identifying a number of occurrences of each sub-portion in test plan 106X.

Impact report generator 802 searches test plan 106X for instances or occurrences of the selected sub-portion to be removed (S912). For a first iteration, a second iteration, a third iteration and a fourth iteration of operation S912, impact report generator 802 searches test plan 106X for occurrences of test item #1, test item #2, test item #3 and test item #4 repectively.

Impact report generator 802 ascertains whether selected sub-portions were found in test plan 106X (S914). If a selected sub-portion is found, a counter related to the selected sub-portion is incremented to indicate an occurrence was found; subsequently, processing continues to operation S916 in which a counter related to the located sub-portion is incremented. Processing passes back to operation S912 in which test plan 106X is searched again for other occurrences of the selected sub-portion. For a first iteration, a second iteration, a third iteration and a fourth iteration of operation S914, impact report generator 802 locates one occurrence of test item #1, ten occurrences of test item #2, twelve occurrences of test item #3 and zero occurrences of test item #4 respectively. When no additional occurrences of a selected sub-portion can be found in test plan 106X, processing continues to operation S918 in which impact report generator 802 records a number of occurrences of located sub-portions in impact report 804. For a first iteration, a second iteration, a third iteration and a fourth iteration of operation S918, impact report generator 802 writes, to impact report 804, one occurrence of test item #1, ten occurrences of test item #2, twelve occurrences of test item #3 and zero occurrences of test item #4 repectively.

Impact report generator 802 ascertains whether there are additional sub-portions to be selected from a portion of a test plan to be removed (S920). If there are more sub-portions to be selected and searched, processing continues to operation S908. If there are no more sub-portions to be selected and searched, processing continues to operation S922 in which operations of impact report generator 802 stops.

Advantageously, the present invention provides a system that allows developers to reduce the amount of time required to generate test plans so that the developers can spend more time testing computer software and resolving defects related to the computer software. Reducing time required for writing the test plan allows the developers to spend more time for other important tasks.

In embodiments that provide a method for generating a test plan, the method can include an additional operation for generating an impact report. Alternatively, the operation for generating the impact report can include operations for identifying a portion of test plan to be removed from a test plan, in which the portion of test plan has sub-portions, operations for removing the portion of test plan from the test plan to generate a modified test plan, operations for comparing the portion of test plan against the modified test plan, and operations for generating the report to indicate the sub-portions and corresponding occurrences of the sub-portions in the modified test plan. In another embodiment, a separate method can be provided for generating an impact report.

Another embodiment of the present invention provides a computer program product for use with a computer including a central processing unit and random access memory, the computer program product includes a computer usable medium having computer readable code (written in a computer programmed instructions) embodied in the medium. The computer program product includes computer readable program code for instructing the computer to implement operations of the methods detailed in the paragraph above.

Impact report generator 802 can be further adapted to provide a summary of test case which include an identified item. Impact report generator 802 can be further adapted to provide a method for data mining a test plan. Data mining can be used for assessing an impact of removing a test case from a test plan. For example, referring to the below-listed table, a condition which might be checked is what is the impact if test case STRAIX101 were removed from the test plan. The query might reveal information such as overall coverage of LDAP support decreases by 25% and coverage of this feature on the AIX operating system drops by 50%.

Impact report generator 802 can be further adapted to provide a summary of test case(s) which include an identified item. The summary identifies new functional features of newly developed computer software or identifies items added to a test plan related to a current version of computer software. For example, a software developer coding LDAP functional support may be interested in examining test cases which are involved in testing LDAP functional support. An example of a summary of test coverage follows.

Summary of test coverage

| Item | Test case(s) covering the item |
|---|---|
| LDAP Support | STRAIX101, STRSUN101, COXAIX105, |
| | COXSUN101 |

Advantageously, the present invention permits added flexibility in printing sections of a test plan. During a review process, it is not expected that each reviewer would comment on an entire test plan (particularly for testing computer software having a large amount of code/function). Some test plans may include a multitude (hundreds or thousands) of test cases and may extend over hundreds of printed pages. For this case, specific test plan reviewers having expertise in a particular item/function are identified. For example, a particular software developer who is responsible for porting computer software to the Hewlett Packard™ (HP) Operating System is identified for reviewing test cases related to the HP platform. The identified reviewer can be sent an entire test plan (in which they wade through many pages to locate the test cases of interest) or identified reviewer can be sent a cut and paste of applicable test cases into a new tailored document. It will be appreciated that both situations waste valuable time.

Advantageoulsy, the invention improves consistencey in terminology and test plan format. There are many ways to structure an outline of a test case. For example, a tabular format can be used in a test plan description to outline test coverage for various test cases, or title sections can be used with ordered lists for itemizing or describing test coverage. A specific outline format is not necessarily better than another outline format; however, it makes it difficult for developers who are not members of a test team for reviewing the test plan. A consistently applied outline format would make it easier for developers to read an entire test plan.

The present invention may be embodied in other specific forms without departing from the spirit or essential characteristics thereof. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

The embodiments of the invention in which an exclusive property or privilege is claimed are defined as follows:

1. A method for generating a test plan having a plurality of directions for testing a component of computer software, comprising:
inserting test items into a component test plan based on a distribution list identifying limits for including occurrences of test items in said component test plan, each test item identifying a test for a component of computer software, said component test plan providing a collection of tests for testing a component of computer software.

2. The method of claim 1 wherein said each test item identifies a direction for testing an aspect corresponding to said component of computer software.

3. The method of claim 1 further comprising inserting said component test plan in said test plan.

4. The method of claim 1 further comprising organizing said test items into groups of test cases, wherein each group of test cases includes a unique combination of occurrences of said test items.

5. The method of claim 1 wherein each said test item is for testing one of a feature, a task, and a function corresponding to said component of computer software.

6. The method of claim 4 further comprising limiting the number of occurrences of items in each test case.

7. The method of claim 1 further comprising generating a distribution list used for generating a test plan having test items for testing components of computer software.

8. The method of claim 7 wherein said generating said distribution list comprises:
determining a correspondence between defects and functions of components of computer software;
determining a correspondence between said functions and said test items to be included in a test plan, each test item testing for a component of computer software; and
determining a limit of occurrences of test items based on a determined correspondence between defects, functions and test items.

9. The method of claim 1 further comprising generating an impact report.

10. The method of claim 9 wherein said generating said impact report comprises:
identifying a portion of test plan to be removed from a test plan, said portion of test plan having sub-portions;
removing said portion of test plan from said test plan to generate a modified test plan;
comparing said portion of test plan against said modified test plan; and
generating said report indicating said sub-portions and corresponding occurrences of said sub-portions in said modified test plan.

11. A computer program product for use with a computer including a central processing unit and random access memory, said computer program product including a computer usable medium having computer readable code means embodied in said medium, said computer program product comprising computer readable program code means for instructing said computer to implement the method of any one of claims 1 to 10.

12. A method for generating a distribution list used for generating a test plan having test items for testing components of computer software, comprising:
determining a correspondence between defects and functions of components of computer software;
determining a correspondence between said functions and said test items to be included in a test plan, each test item testing for a component of computer software; and
determining a limit of occurrences of test items based on a determined correspondence between defects, functions and test items.

13. A computer program product for use with a computer including a central processing unit and random access memory, said computer program product including a computer usable medium having computer readable code means embodied in said medium, said computer program product comprising computer readable program code means for instructing said computer to implement the method of claim 12.

14. A method for generating an impact report comprising:
identifying a portion of test plan to be removed from a test plan, said portion of test plan having sub-portions;
removing said portion of test plan from said test plan to generate a modified test plan;
comparing said portion of test plan against said modified test plan; and
generating said report indicating said sub-portions and corresponding occurrences of said sub-portions in said modified test plan.

15. The method of claim 14 further comprising:
selecting said sub-portions;
searching said modified test plan for occurrences of said sub-portions; and
counting said occurrences of said sub-portions.

16. A computer program product for use with a computer including a central processing unit and random access memory, said computer program product including a computer usable medium having computer readable code means embodied in said medium, said computer program product comprising computer readable program code means for instructing said computer to implement the method of any one of claims 14 and 15.
